(19) United States
(12) Patent Application Publication
(10) Pub. No.: US 2023/0151765 A1
(43) Pub. Date: May 18, 2023

(54) TANGENTIAL TURBOFAN PROPULSION SYSTEM

(71) Applicant: Robert Bado, Delray Beach, FL (US)

(72) Inventors: Robert Bado, Delray Beach, FL (US); Artem Madatov, North Bethesda, MD (US)

(21) Appl. No.: 18/093,166

(22) Filed: Jan. 4, 2023

(51) Int. Cl. F02C 3/045; F02C 7/232; F02C 7/266; F23R 3/42

(52) U.S. Cl. CPC F02C 3/045; F02C 7/232; F02C 7/266; F23R 3/425; F05D 2220/323; F05D 2240/35; F05D 2240/36

(57) ABSTRACT

The present invention is a turbofan propulsion system, based on a tangential gas turbine that is structurally a part of the propulsion system's centrifugal compressor, wherein the gas turbine's combustion chambers with nozzles are placed to rotate around a larger radius circle at a supersonic circumferential speed, and the fan blades are placed to rotate around a smaller radius circle at a subsonic circumferential speed, therefore increasing the efficiency of the propulsion system.

### FIELD OF THE INVENTION

The present invention generally relates to turbofan propulsion systems for aircraft.

### BACKGROUND OF THE INVENTION

Aircraft gas turbines and ramjet engines are widely used propulsion systems with excellent figures of specific thrust in kgf/kg and specific fuel consumption per unit of thrust per hour in kg/kgf*hour.

The design of ramjet engine (aero thermodynamic duct), a form of airbreathing jet engine that uses the forward motion of the engine to produce thrust, is the simplest among all thermal engines. The efficiency of ramjet engines is the highest among all other thermal engines. However, their main disadvantage is they produce no thrust when stationary (no ram air) and are most efficient only at supersonic speeds. Therefore, ramjet-powered vehicles require an assisted take-off, and are pre-accelerated to the speed of sound using turbojet engines in aircraft, or using a rocket booster in missile.

A gas turbine, also called a combustion turbine, is a type of continuous flow internal combustion engine, consisting of a rotating gas compressor, a combustor and a compressor-driving turbine. The thermodynamic cycle of a gas turbine engine consists of atmospheric air flows through the compressor that brings it to higher pressure; energy is then added by injecting fuel into the air and igniting it so that the combustion generates a high-temperature flow; this high-temperature pressurized gas enters a turbine, producing a shaft work output in the process, used to drive the compressor; the unused energy is dispersed in the exhaust gases.

The manufacturing cost of gas turbines is higher than that of other thermal engines.

There are axial, radial, tangential and transverse (lateral) types of gas turbines. Tangential jet turbines are of greatest interest because they can operate without rotor blades. In tangential jet turbines, the torque on the rotor is created by a reactive force of the tangentially directed outflow jet from rotating nozzles.

In the 20th century, several designs of tangential turbofan jet engines were developed. The following prior arts have been used by the present inventors as analogues and prototypes in the development of the present invention.

One of such turbines is Rotary Jet Reaction Turbine (U.S. Pat. No. 43,336,374A), a jet type engine that includes a rotor through which air is drawn and compressed by centrifugal force with the air thus heated and compressed being mixed at the periphery of the rotor with fuel to ignite the same and establish a jet which causes the rotor to rotate. In some cases the air may be precompressed prior to its delivery to a hollow shaft from which it travels radially outwardly through hollow spokes for compression and heating prior to its mixture with fuel that is introduced through a small tube extending through a corresponding one of such hollow spokes. The resulting combustion gases are directed through guides onto turbine buckets on a second rotor which rotates in a direction opposite to that of the air and fuel conducting rotor and the exhaust gases are discharged in a direction extending parallel to the axis of rotation, i.e., sideways. A common output shaft is coupled to these two oppositely rotating rotors for powering, for example, an automobile with energy derived from both such rotors.

The advantage of the described engine is the constructive integration of the centrifugal compressor located in the spokes of the turbo wheel with the turbine rotor. Design complexity and necessity of torque synchronizing are the disadvantages of such engine.

The invention according to patent Thermal Engine with Rotating Nozzles (FR934755A) describes a rotary turbine with rotating nozzles, in which thrust is tangentially applied to the rotor, characterized by the use of combustion products as the working fluid, characterized by the arrangement of the combustion chamber in the plant, wherein the combustion chambers being formed at least partly in the turbine rotor or in another rotating part of the plant, and the combustion chamber contributes to the driving force by creating reactive thrust.

The engine according to patent Rotary Turbine Engine of the Reaction Type (WO2000039440A1) is a a rotary turbine engine of the reaction type, comprising an impeller with shaped blades, an impeller rotation axis, an inlet of the fluid between the blades, combustion chambers between said blades, and a fluid shaped outlet. Combustion chambers and nozzles are fixed on the rotor. A compressor is mechanically connected to the rotor for compressing air within the air intake. Fuel is supplied to the combustion chambers through fuel lines and nozzles from the fuel pump.

The torque in a tangential turbine is created by reactive thrust force of hot gases flowing out of the tangentially directed nozzle(s). As a result the rotor rotates around its axis. The thrust force performs the work equal to the thrust force multiplied by the distance traveled by the nozzle. The higher the velocity of the gas flowing out of the nozzle, the higher the efficiency of thermal energy conversion into mechanical energy. The efficiency of a jet engine substantially increases when the flowing gas velocity exceeds the speed of sound.

The efficiency of the tangential turbine increases when the circumferential speed of the rotating rotor with nozzles becomes supersonic.

Considering all of the above, the present inventors have developed a turbofan propulsion system, based on a reactive tangential turbine, with increased efficiency, simplified design, reduced manufacturing costs and increased service life.

### SUMMARY OF THE PRESENT INVENTION

The present invention is a turbofan propulsion system, based on a tangential gas turbine that is structurally a part of the propulsion system's centrifugal compressor, wherein the gas turbine's combustion chambers with nozzles are placed to rotate around a larger radius circle at a supersonic circumferential speed, and the fan blades are placed to rotate around a smaller radius circle at a subsonic circumferential speed, therefore increasing the efficiency of the propulsion system. The said turbofan propulsion system is distinguished by the following features:
1. Integrated design of the gas turbine and the fan for direct transmission of torque from the gas turbine to the turbofan.
2. Gas turbine nozzles are placed to rotate at a circle of the diameter larger than the diameter of the turbofan, wherein the turbofan is placed inside the gas turbine. Therefore, at the same angular velocity, the gas turbine nozzles cover a longer circumferential distance, and the fan blades cover shorter circumferential distance. The gas turbine essentially acts as the turbofan's outer rim, wherein the fan blades act as the turbofan's spokes.
3. The angular speed of the propulsion system is so chosen that the speed of the fan blades is subsonic, and the speed of the gas turbine's combustion chambers with nozzles is supersonic. Thus making the propulsion system as efficient as possible.
4. The gas turbine is of bladeless tangential type, comprising the rotating direct-flow compression and combustion chambers and nozzles, ensuring approximately double the efficiency of the propulsion system and reducing the specific fuel consumption.
5. In addition, the gas turbine is equipped with a centrifugal compressor for energy efficient operation at low speeds. Switching between the low- and high-speed modes is carried out automatically using the valves placed within the dynamic compression chambers.
6. The centrifugal compressor is structurally combined with the turbofan, wherein the radial air supply channels of the centrifugal compressor are placed within the hollow fan blades.
7. The fuel supply channels for the gas turbine's combustion chambers are also radially placed inside the hollow fan blades, therefore ensuring a high fuel pressure in the fuel injectors at the ends of the said channels due to the centrifugal force present within the rotating fuel supply channels. This embodiment simplifies the fuel supply, makes the fuel system reliable and lightweight.
8. The supply of fuel to the fuel supply channels is performed through a hollow shaft of the turbofan rotor, wherein the fuel channels are structurally connected to the said shaft by a hermetic connection. The suction of fuel into the shaft from a fuel tank and the fuel's further movement through the said shaft occurs due to a centrifugal pressure gradient in the radial direction from the shaft to periphery via the fuel supply channels.
9. The working parts of the gas turbine, namely the rotating combustion chambers with combustion gas exhaust nozzles, are tangentially placed within the turbofan rotor's plane of rotation, and the jet axis of each nozzle is tilted at an acute angle to the said rotor's radius so that the hot combustion gases flowing out from the nozzles pass between the fan blades, mixing with the air flowing through the the said blades, increasing the temperature of the colder air captured by the turbofan, thus, increasing the air volume and the efficiency of the turbofan.

### BRIEF DESCRIPTION OF THE DRAWINGS

FIG. 1 shows top and side schematic views of the tangential turbofan propulsion system.

FIG. 2 shows the operating principle of the tangential turbofan propulsion system.

FIG. 3 shows a schematic view of the ramjet channel with the fuel and compressed air supply channels integrated with the fan blade.

FIG. 4A shows schematic view of the ramjet channel operating mode with the closed air intake.

FIG. 4B shows schematic view of the ramjet channel operating mode with the open air intake.

FIG. 5 shows the schematic view of the fuel injection and ignition within the combustion chamber.

FIG. 6 shows top and side partial cross section schematic views of the tangential turbofan propulsion system, demonstrating direction of rotation and thrust under the applied force of jet stream.

### DETAILED DESCRIPTION OF THE PRESENT INVENTION

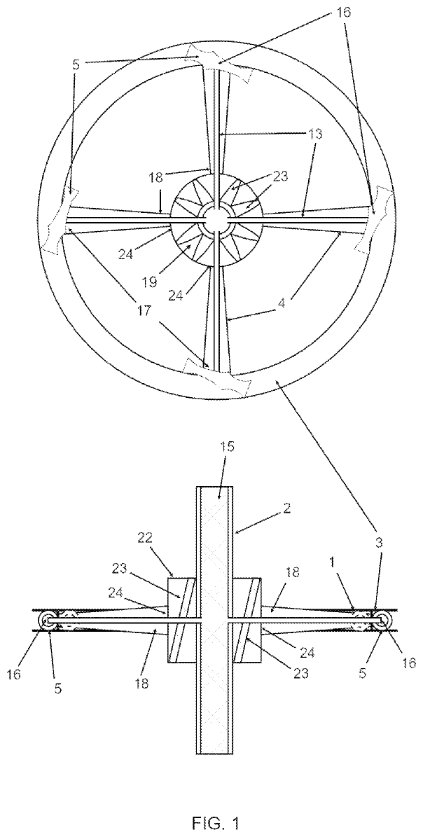

The present invention provides a tangential turbofan propulsion system, comprising a rotor 1 and a hollow shaft 2 placed to rotate around an axis of rotation (FIG. 1), wherein a rotor rim 3 is of a U-shape profile with outward facing U-channel, ensuring the rim rigidity and high level of resistance to centrifugal forces. The shaft and the rim are interconnected by a plurality of at least two rigid radial wheel spokes 4, providing rigidity and stability to the rotor, which rotates at high speed (FIG. 1).

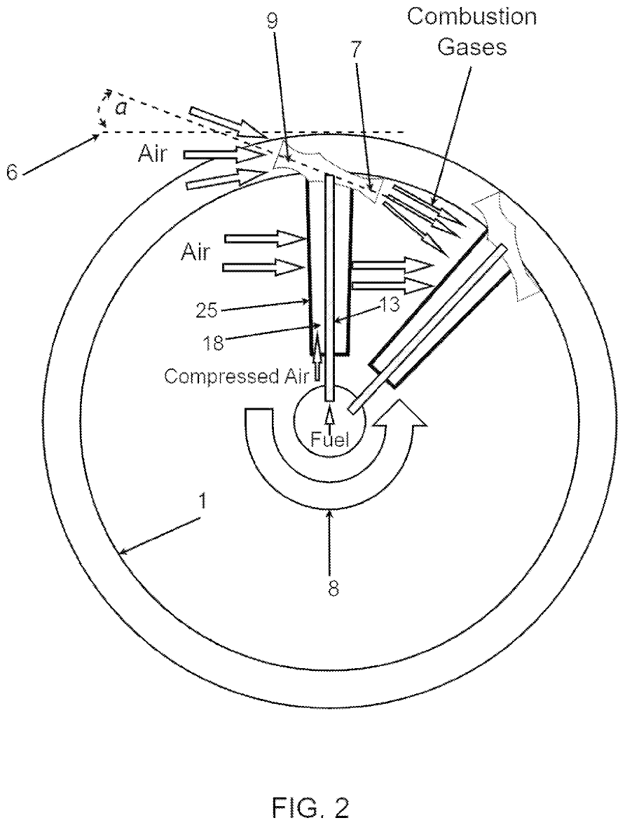

A plurality of at least two identical ramjet channels 5 are rigidly placed inside the rim 3 along its circumference (FIG. 1). The longitudinal axes 6 of the said channels 5 are tangentially directed relative to the circumference of the rotor 1, and a nozzle 7 of each of the said channels 5 is open in the direction opposite to the rotor's rotation's direction 8 (FIG. 2).

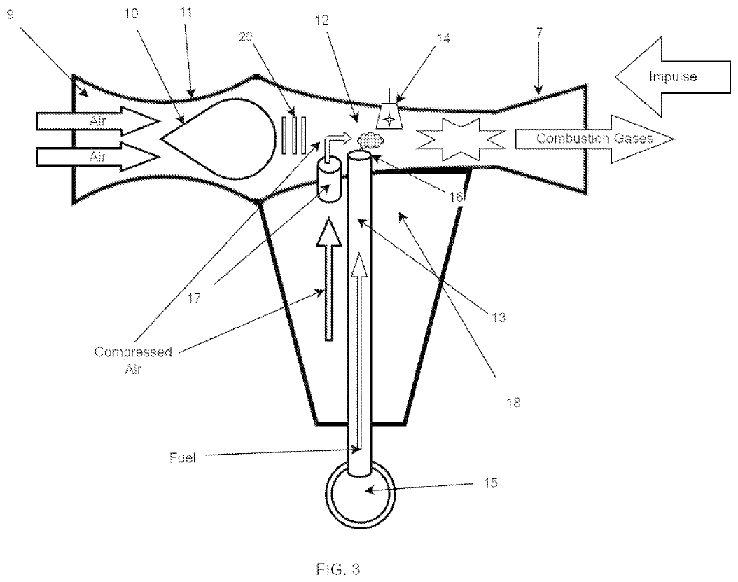

Each ramjet channel 5 comprises an air intake 9 with a centrally placed body-fairing 10 and an annular diffuser 11, a combustion chamber 12, a fuel supply channel 13, a spark plug 14, the nozzle 7 (De Laval-type nozzle) (FIG. 3). The fuel supply channel 13 connects fuel supply channel 15 of the hollow shaft 2 of the rotor and a fuel injector 16 inside the combustion chamber 12 of the ramjet channel 5 (FIG. 3). The liquid fuel supplied through the fuel channels 13 is injected through the injectors 16 into the combustion chambers 12. Each combustion chamber 12 is additionally equipped with a side air inlet 17 (FIG. 3) for incoming compressed air from a radial channel 18 of a centrifugal compressor 19 (FIG. 1).

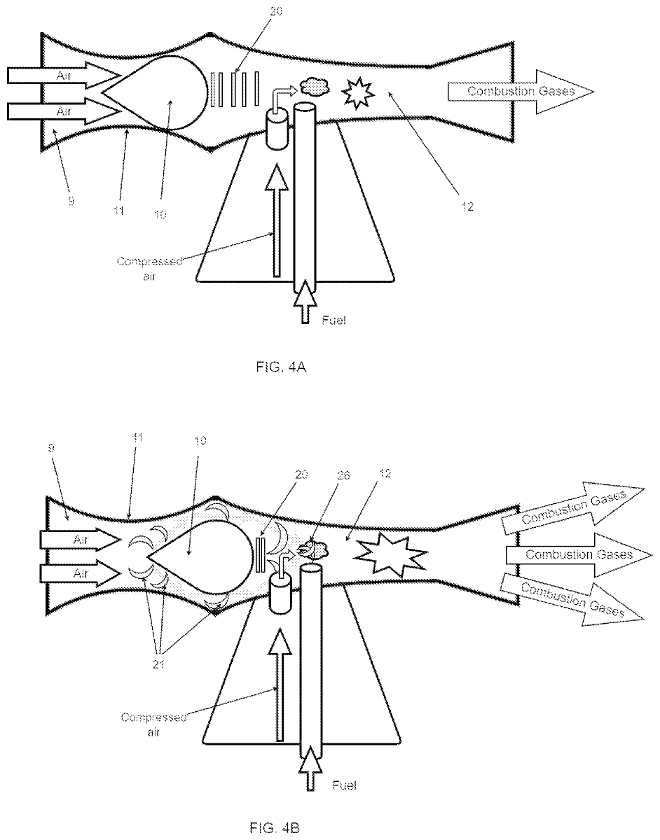

The ramjet channel 5 is a variable cross-section pipe with two successive constrictions and the said nozzle 7 at the channel's back end (FIG. 3). Wherein, the front end of the channel, open in the direction of rotation, is the air intake 9. The first constriction facing the direction of rotation, comprises the said body-fairing 10 and the annular diffuser 11. The said body-fairing 10 is in form of a body of revolution with a pointed front to reduce aerodynamic drag. The said body-fairing is designed with an axial displacement capability supported from its rear end by a spring 20, wherein the body-fairing forward motion is limited by the said annular diffuser, which is structurally a part of the said ramjet channel's wall (FIG. 3). While the said body-fairing 10 is in its extreme forward position a gap between its lateral surface and the inner surface of the said diffuser 11 is eliminated, thus preventing the air inflow from the air intake 9 into the combustion chamber 12 (FIG. 4A).

The body-fairing 10, while in its rear position opens up the air intake 9 for the air incoming from the compressor 19 into the combustion chamber 12 (FIG. 4B). Thus, the body-fairing 10 acts as an air valve that at a subsonic speed of the oncoming air flow ensures the combustion chamber receives the air flow coming only from the compressor 19. This mode is used to start up the propulsion system, and is characterized by low thrust, low fuel consumption. However, when the fuel is supplied to all combustion chambers, the rotor swiftly reaches a supersonic circumferential speed. For example, an angular speed of 4000 rpm of a 1500 mm diameter rotor corresponds to a supersonic circumferential speed.

At a supersonic speed of the oncoming airflow, the dynamic pressure applied to the body-fairing 10 pushes it back by overcoming resistance of the spring 20, and automatically opens up the air inflow from the air intake 9 to the combustion chamber 12. In this mode, the engine operates as a scramjet: the air is compressed by shock waves 21 to a high degree of compression, the airflow velocity inside the chamber 12 becomes supersonic, the combustion of fuel in the combustion chamber 12 is of detonation-type, the speed of the combustion gas outflow through the critical section of the ramjet is supersonic, and the De Laval-type nozzle 7 further accelerates the exhaust gases and increases the efficiency of the propulsion system (FIG. 4B).

The propulsion system's starting compressor 19 has two stages: axial and radial. The said compressor is rigidly attached to the shaft 2 and rotates with it.

The axial part of the compressor 22, is a an air intake forward open in the direction of motion. Oblique profiled blades 23 are placed on the inner surface of the air intake bowl, capturing air during rotation, compress it and direct it to the radial stage of compressor through windows 24 in the side walls of the said bowl-shaped air intake (FIG. 1).

Each window 24 passes the compressed air into the radial channel 18 of the compressor's second stage. The radial channels 18 pass placed within the radial spokes 4 of the rotor, are in essence the walls of each radial channel 18, thus forming one rigid radial spoke 4 (FIG. 1). This reduces the quantity, weight and cost of metal to manufacture the propulsion system. The distal end of the each radial channel 18 ends with a side orifice 17 into the combustion chamber 12 (FIG. 3).

The walls of the radial channel 18 of the radial spoke 4 are so shaped that each spoke forms an aerodynamically efficient body, fan blade 25, thus reducing the weight of the propulsion system. In addition, the thin metal walls of the radial channel 18 of the compressor 19 can effectively and quickly cool down the hot compressed air inside the radial channel 18, by transferring heat from the channel to the cold air flowing around the fan blades 25 (FIG. 2), thus increasing air compression ratio and improving system efficiency. All of the above factors significantly increase the specific thrust of the propulsion system, and reduce the specific fuel consumption.

In the present embodiment, the propulsion system is managed electronically and/or electromechanically and/or mechanically, by controlling the amount of fuel getting into the fuel channels 13 and amount of air getting into the radial channels 18. The flow of fuel into the fuel channel 13 and the corresponding combustion chamber 12, and the flow of air into the same combustion chamber through the radial channel 18 of the compressor are managed simultaneously. This is done to reduce the loss of mechanical energy on air compression, preventing its supply into the idle combustion chambers 12.

The said propulsion system must be start-assisted by an external source of mechanical energy, for example compressed air. When the compressed air is supplied through the air intake 22 onto the blades 23, the compressor 19 itself serves as a starter. The compressed air from the said air intake flows through the windows 24 into the radial channels 18, then through the side orifices 17 into the combustion chambers 12. At this time, the combustion chambers are closed from the side of the air intakes 19 by their respective body-fairings 10, forcing the compressed air flow out of the nozzles 7 creating a jet thrust. The thrust force is directed tangentially relative to the rotor rim 3 and causes the rotor 1 to rotate in the opposite direction.

When the said rotor reaches sufficient rotational speed, the compressor starts capturing air through the air intake 22 and compresses it in the radial channels 18 under the centrifugal force. As a result of the air moving into the distal part of the narrowing radial channels 18, the air is getting heated and compressed. At the end of the radial channels 18, compressed and heated air passes through the narrow side orifices 17 into the combustion chambers 12 of the turbine (FIG. 3).

When the rotor 1 with the radial fuel channels 13 rotate, a pressure gradient is created in the said channels by a centrifugal force, directed from the center of rotation to the periphery. Thus, a significant pressure is created in front of the injectors 16, and a rarefaction is created at the distal end of the fuel channels 13. As a result, the fuel is being sucked out of a fuel tank (not shown) through the hollow rotor shaft 2. The rotating radial fuel channels 13 act as a centrifugal fuel pump. The higher the angular speed of the rotor the more fuel is supplied to the combustion chambers 12.

The fuel is injected under pressure from the radial fuel channels 13 through the injectors 16 into the chambers 12 and ignited by the spark plug 14 (FIG. 3). The fuel-air mixture within the said chambers reaches temperature of over than 600° C. Due to the high temperature, new portions of the supplied fuel evaporate, mix with air and combust in a short time. The volume of the hot combustion gases significantly exceeds the volume of the air supplied from the compressor 19 through the side orifices 17, so the pressure in the combustion chamber 12 substantially increases (FIG. 3).

Displaced by the new portions of air coming under pressure from the radial channels 18 of the compressor 19 into the combustion chambers 12, the combustion gases move along the pressure gradient through the ramjet channels 5 and are being ejected through the nozzles 7 (FIG. 4A).

When flowing out of the nozzles 7, the combustion gases acquire higher than supersonic velocity and some momentum. According to the law of conservation of momentum, the said nozzles receive an impulse equal in magnitude, but opposite in direction. This impulse is realized in form of thrust force applied to the nozzles 7, and therefore, to the rotor 1.

Thrust force from the plurality of nozzles 7, tangentially directed relative to the rotor's 1 circumference, causes it to rotate in the direction opposite to the combustion gases jet.

As the angular velocity of the rotating rotor increases, the linear circumferential speed of the combustion chambers 12 with air intakes 9 increases accordingly. When the circumferential speed of the rotor becomes supersonic, the oncoming air flow pressure in the air intakes 9 begins exceeding the pressure of the air flow coming from the radial channels 18 of the centrifugal compressor 19. When the force of the dynamic air pressure applied to the body-fairing 10 exceeds the force of the centrifugal air pressure, the spring 20 begins compressing, the said body-fairing moves backward and opens the air inlet to the combustion chambers 12 from the air intakes 9 (FIG. 4B). Air enters the said combustion chambers simultaneously from the air intakes 9 and from the radial channels 18, thus increasing the amount of air entering the combustion chambers 12 up to five-fold.

Air flowing at supersonic speed creates on the body-fairing 10 the shock waves 21, which are then reflected from the diffuser 11 and the channel 5 walls, moving along the combustion chambers 12 at supersonic speed (FIG. 4B). Therefore, the air coming from the air intake 9 does not force the air coming from the radial channels 18 of the compressor 19 back into the said radial channels. On the contrary, the vacuum that occurs behind the diffuser 11 when a supersonic shock wave 21 moves through the gap between the body-fairing 10 and the diffuser 11, sucks air from the radial channel 18 into the combustion chamber 12. As a result, the air compression ratio in the combustion chambers 12 increases by 40-50 times. This is comparable to that of the best turbojet engines.

Simultaneously, with the increase of the angular velocity of the rotor, the fuel pressure in the injectors 16, created by the centrifugal force in the radial fuel channels 13, increases.

The fuel consumption through the said injectors also increases. As a result, the speed of the combustion gases ejected out of the combustion chambers 12 through the nozzles 7 increases significantly, thus increasing the power on the shaft 2, and the turbine changes its operational mode from starting to working. The air-fuel ratio of the mixture entering the combustion chamber 12 is adjusted in advance and remains constant (optimal) regardless of the angular speed of the turbine. Since both the pressure of the fuel in the injectors 16 and the pressure of the air entering the combustion chambers 12 are a function of the angular velocity of the rotor, their said ratio is preserved. This ensures the most complete combustion of fuel and efficient operation.

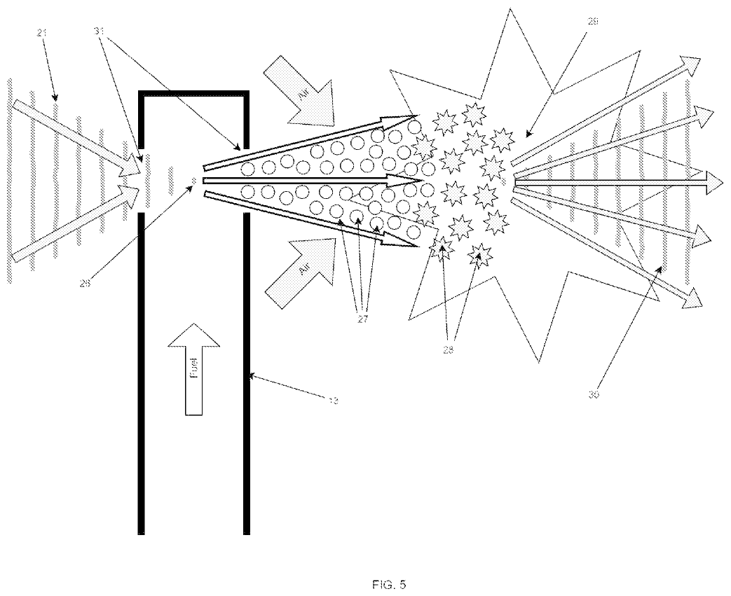

The relative spatial orientation of the body-fairing 10 and the diffuser 11 is so chosen that the shock air waves 21 from the said body-fairing move towards the said diffuser, and, reflecting from its oblique walls, are focused behind the diffuser at the spatial point 26, which lies on the axis of the combustion chamber 12 (FIG. 5). A narrow region of high pressure (over 100 atm) appears at the said shock wave focus point, and a large pressure gradient is created around this point. It is recommend the fuel to be injected to the said focus point to atomize the fuel into sub-micron droplets 27. Due to the air temperature in the focus point of shock waves being around 1000° C., the injected fuel instantly turns into vapor 28, which mixes with the hot air present in the combustion chamber 12. Due to explosive evaporation, the pressure in the narrow central combustion zone 29 further increases, causing detonating combustion. As a result, the combustion products axially propagate in the direction of the nozzle 7 as supersonic shock waves 30 (FIG. 5). The De Laval-type nozzle 7 further increases the speed of gases flowing out of the combustion chamber 12 and increases the efficiency of the turbine.

For efficient atomization of fuel in focused shock air waves, it is recommended using the following type of injectors. The radial fuel channel 13 is plugged at the combustion chamber end, and has a through hole 31 near its plugged end, coaxial with a longitudinal axis of the combustion chamber 12 and spatially coinciding with the focus point 26 (FIG. 5). Shock air waves 21, passing through the hole, disperse the fuel coming through the radial fuel channel 13, evaporate it, and, swirling at the edges of the hole, quickly mix the fuel vapor with the hot air. Such mixture, highly compressed and heated, moves along the combustion chamber 12 until it explodes either spontaneously (when the temperature rises to the ignition temperature) or by a spark plug.

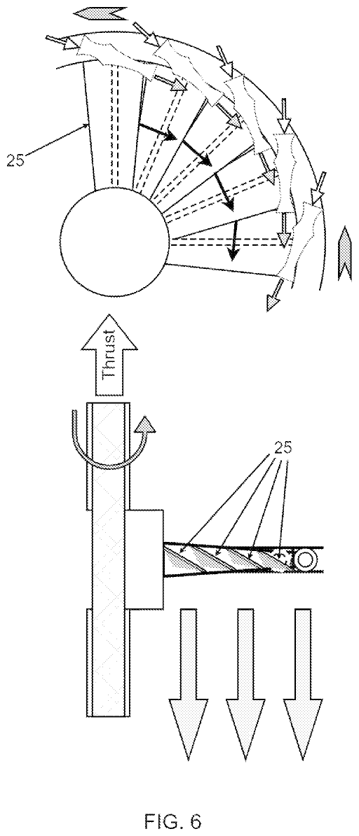

The hot combustion gases flowing out of the nozzles 7 are directed at some sharp angle a to the tangent of the rotor's circumference, so that the said gases mix with air captured by the fan blades 25 (FIG. 2). The hot combustion gases from the said nozzles mix with the air flowing between the said blades and heat it up (FIG. 6). The volume of air moved by the blades 25 increases and the efficiency of the fan propulsion increases due to the residual heat of hot gases. The rotating fan blades 25 capture air and axially move it backwards. The axial fan propulsion generates forward thrust.

The said fan blades 25 are made of metal of aerodynamic shape: streamlined profile, optimal angle of attack, twist of the blades (change in angle of attack depending on the radius). Therefore, through the blade's metal walls the heat exchange effectively occurs between the heated air inside the radial channel 18 structurally integrated with the said blades and the cold outside air, blowing around the blade. Outside air, passing through the turbofan, heats up and increases in volume (FIG. 2). Due to the increase in volume, the speed of the jet flowing from the fan increases. Thus, the fan thrust increases, and part of the waste thermal energy from air compression is converted into mechanical thrust energy of the propulsion system.

The heated air inside the channel 18 is being cooled, thus reducing its volume and, consequently, its pressure. The resistance to air compression within the said channel decreases and the efficiency of the centrifugal compressor 19 increases. It captures a larger mass of air. A larger mass of air of the same pressure enters the combustion chambers 12, thus the mass, and, hence, the volume of combustion products increases. As a result, the specific power of the engine and the propulsion thrust increase.

Due to the placement of fuel channels 12 inside the blades 25, the fuel inside the said channels is getting preheated. The warmer fuel, due to a decrease in viscosity and surface tension, is injected in smaller drops and burns more completely.

The power output control of the propulsion system is performed by managing the supply of fuel to the combustion chambers 12.

1. A turbofan propulsion system based on a rotary gas turbine of tangential type, comprising a fan with a plurality of at least two blades for capturing and moving air, driven by the gas turbine, a rotor with a plurality of at least two fuel combustion chambers with De Laval-type nozzles, a plurality of at least two fuel channels with injectors supplying liquid fuel to the said combustion chambers equipped with spark plugs, an axial dual-stage compressor with oblique blades, characterized in that the said compressor is structurally integrated with the said rotor, and is connected to the said combustion chambers, wherein the second air compression stage of the said dual-stage compressor, comprising a plurality of at least two radial channels mechanically connected to the said rotor, and connected by their inward facing ends with the first axial stage of the said compressor, and by their outward facing ends connected with the said fuel combustion chambers located on the said rotor's periphery.

2. The gas turbine according to claim 1, characterized in that each of the said combustion chambers is equipped with an air intake open towards the direction of movement of the said chamber when the rotor rotates at supersonic speed, wherein inside the air intake there is a body-fairing and an annular diffuser that provide dynamic braking and compression of the incoming air flow into the said combustion chamber by creating, reflecting and focusing supersonic shock air waves.

3. The gas turbine according to claims 1-2, characterized in that each of the said radial air channels of the compressor is connected to the combustion chamber through an orifice in the sidewall of the said combustion chamber, which is located behind the diffuser in the area of reduced air pressure.

4. The gas turbine according to claims 1-2, characterized in that the axially-movable spring-supported body-fairing is axially placed behind the annular diffuser, wherein the said body-fairing is capable of moving along the axis of symmetry of the diffuser under the elastic force of the supporting spring and under the pressure force of the oncoming air flow, so rated that at a subsonic speed of the oncoming air flow, the body-fairing completely blocks the flow of air through the air intake, and at a supersonic speed of the oncoming air flow, the body-fairing compresses the spring under the pressure of oncoming air, moves backward and maximally opens the flow of air through the air intake.

5. The turbofan propulsion system according to claim 1, characterized in that the combustion chambers with nozzles of the gas turbine are placed on the periphery of the rotor, wherein the hollow fan blades are radially placed inside the rotor, and rigidly attached to it, and wherein the radial air channels of the second stage of the compressor are placed inside and structurally integrated with the said hollow fan blades, and the fuel supply channels are placed inside the said radial air channels.

6. The gas turbine according to claims 1 and 5, characterized in that the fuel channels placed inside the hollow fan blades connect the fuel supply channel located within the hollow shaft of the rotor and, through injectors, the combustion chambers, so when the rotor rotates, the centrifugal force creates a pressure gradient directed from the central fuel supply channel to the injectors.

7. The gas turbine according to claims 1-2, characterized in that the fuel supplied to each combustion chamber is injected into the focus point of supersonic shock waves, through the fuel injector in form of a through hole near a plugged end of the radial fuel supply channel, coaxial with a longitudinal axis of the combustion chamber and spatially coinciding with the said focus point, and the axis of this hole coincides with the direction of propagation of supersonic shock waves, so that supersonic shock waves pass through the hole and atomize the fuel into a fine misted spray.

8. The gas turbine according to claim 1, characterized in that the rotating combustion chambers with De Laval-type nozzles have a longitudinal axis within the plane of rotation of the rotor, and the direction of the axis of each nozzle is inclined towards the axis of rotation by an acute angle so that hot combustion gases flowing from the nozzles pass between the fan blades mixing with the air moved by the fan blades.
